(19) United States
(12) Patent Application Publication
(10) Pub. No.: US 2012/0158453 A1
(43) Pub. Date: Jun. 21, 2012

(54) WORKFLOW PROCESSING SYSTEM FOR SUPPORTING MULTI-TENANT, AND METHOD THEREOF

(75) Inventors: Moon Young CHUNG, Daejeon (KR); Hee Sun WON, Daejeon (KR); Sung Jin HUR, Daejeon (KR)

(73) Assignee: Electronics and Telecommunications Research Institute, Daejeon (KR)

(21) Appl. No.: 13/308,732

(22) Filed: Dec. 1, 2011

(30) Foreign Application Priority Data
Dec. 16, 2010 (KR) 10-2010-0129530

(51) Int. Cl. G06Q 10/06

(52) U.S. Cl. 705/7.26

(57) ABSTRACT

Provided is a workflow processing system and method for supporting the multi-tenancy in a software as a service (SaaS) environment. Proposed is a method of configuring a workflow, defined based on an activity for each tenant, to share a single workflow instance in the multi-tenancy support environment. In particular, proposed is a method of editing a workflow for each tenant by a workflow editor and performing configuration for each activity that constitutes the workflow. In addition, proposed is a method of storing and managing a configured activity as metadata. In particular, proposed is a method of storing metadata for each activity when storing an activity through a workflow editor.

### CROSS-REFERENCE TO RELATED APPLICATIONS

This application claims priority to and the benefit of Korean Patent Application No. 10-2010-0129530 filed in the Korean Intellectual Property Office on Dec. 16, 2010, the entire contents of which are incorporated herein by reference.

### TECHNICAL FIELD

The present invention relates to a workflow processing system and method for supporting the multi-tenancy. More particularly, the present invention relates to a workflow processing system and method for supporting the multi-tenancy in a software as a service (SaaS) environment.

### BACKGROUND

With development of a reliable large capacity Internet access technology and a service-oriented architecture technology, and with increase in maintenance and repair cost of package software, a web based service of a new scheme called software as a service (SaaS) is rapidly growing. In a conventional art, large cost is required to provide the same service to a plurality of tenants. To reduce the cost, a single service is provided using a web based multi-tenant supporting scheme in a SaaS environment. Also, in the conventional art, to provide a service to a single tenant, exclusive resources including software, hardware, and the like, are allocated to the tenant. However, in the SaaS environment, only a single software instance is managed and can be shared by a plurality of tenants and thereby be used. Accordingly, it is possible to obtain a great economical effect such as a decrease in management cost, a decrease in resource construction cost, and the like.

Many technologies have been proposed to provide a service for enabling the multi-tenancy to share and thereby use a single software instance as if the multi-tenants use a resource dedicated for each group. As one example, To support the multi-tenancy metadata technology, a workflow authentication technology, and the like, are provided. For example, a technology for providing a service that enables each tenant to share and use a single software instance as if each tenant uses a unique service dedicated to a corresponding tenant and configured is very important. Multi-tenant metadata research has been proposed a plurality of technologies, such as schema mapping, a share schema, and the like.

However, in a technology associated with the multi-tenancy support workflow, a configuration method is provided only in a limited area such as a workflow authentication technology and the like. In an existing SaaS environment supporting a workflow, the multi-tenancy is enabled to simply use a workflow engine using an online scheme and a function capable of configuring and using a single defined workflow instance is not supported. Accordingly, a defined workflow is used as is or a new workflow needs to be defined and thereby be used. In this case, compared to providing a single workflow instance to the multi-tenancy, the above method may have high cost and low efficiency in an aspect of resource sharing or resource management.

### SUMMARY

The present invention has been made in an effort to provide a workflow processing system and method that may configure a workflow to be suitable for a tenant environment and thereby support the multi-tenancy in the multi-tenancy support environment.

An exemplary embodiment of the present invention provides a workflow processing system for supporting the multi-tenancy, including: an activity extractor to extract at least one activity associated with a workflow for providing a software service; an activity configuration unit to configure an extracted activity based on a schema customized for a selected tenant; and a storage processing unit to store a workflow that is an activity extraction target and the configured activity.

The workflow processing system may further includes a workflow editor to edit an edition requested workflow by overwriting a first activity, predetermined for each selected tenant, at a second activity location of the edition requested workflow, and a workflow executor to execute an edited workflow for each tenant.

The workflow editor may determines the first activity for each selected tenant based on metadata that is used to associate the configured activity and the workflow that is the activity extraction target. Also, the workflow editor determines the second activity associated with the first activity based on information about an identifier.

The workflow processing system may further includes a workflow processing unit to objectize the execution requested workflow. The workflow editor edits the execution requested workflow by performing activity serialization after the overwriting operation. When the metadata does not exist, the workflow executor commonly executes an unedited workflow with respect to all tenants in which the metadata does not exist.

The storage processing unit may further stores metadata that is used to associate the configured activity and the workflow that is the activity extraction target, and classifies and thereby stores each of the workflow that is the activity extraction target, the configured activity, and the metadata.

The workflow processing system may be driven when tenants desire to share a single workflow.

The activity extractor may extracts at least one activity that is selected from a control functioning activity, an allocation functioning activity, and a system interaction functioning activity.

Another exemplary embodiment of the present invention provides a workflow processing method for supporting the multi-tenancy, the method including: extracting at least one activity associated with a workflow for providing a software service; configuring an extracted activity based on a schema customized for a selected tenant; and storing a workflow that is an activity extraction target and the configured activity.

After the storage processing operation, the workflow processing method may includes editing an edition requested workflow by overwriting a first activity, predetermined for each selected tenant, at a second activity location of the edition requested workflow, and executing an edited workflow for each tenant.

The workflow edition operation may determines the first activity for each selected tenant based on metadata that is used to associate the configured activity and the workflow that is the activity extraction target. Also, the workflow edition operation determines the second activity associated with the first activity based on information about an identifier.

Before the workflow edition operation, the workflow processing method may includes objectizing the execution requested workflow. The workflow edition operation edits the execution requested workflow by performing activity serialization after the overwriting operation. When the metadata does not exist, the workflow execution operation commonly executes an unedited workflow with respect to all tenants in which the metadata does not exist.

The storage processing operation may further stores metadata that is used to associate the configured activity and the workflow that is the activity extraction target, and classifies and thereby stores each of the workflow that is the activity extraction target, the configured activity, and the metadata.

The workflow processing method may be performed when tenants desire to share a single workflow.

The activity extraction operation may extracts at least one activity that is selected from a control functioning activity, an allocation functioning activity, and a system interaction functioning activity.

According to exemplary embodiments of the present invention, the following advantages may be obtained by configuring a workflow to be suitable for a tenant environment in the multi-tenancy support environment. First, it is possible to support a single workflow instance to the multi-tenancy as if an exclusive workflow is allocated to each of the tenants. Second, a resource sharing/management is enabled at low cost and high efficiency as compared to an existing support method.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically illustrating a workflow processing system for supporting the multi-tenancy according to an exemplary embodiment of the present invention.

FIG. 2 is an exemplary diagram showing a system employing a workflow configuration method.

FIG. 3 is an exemplary diagram showing a generally executable workflow.

FIG. 4 is an exemplary diagram showing an activity metadata table.

FIG. 5 is a first exemplary diagram for helping understanding about an activity configuration method of a workflow.

FIG. 6 and FIG. 7 are second exemplary diagrams for helping understanding about an activity configuration method of a workflow.

FIG. 8 is an exemplary diagram illustrating a process of executing a workflow configured for each tenant by replacing an activity when a user requests a workflow execution.

FIG. 9 is an exemplary diagram illustrating a workflow script serialized by overwriting a basic activity.

FIG. 10 is a flowchart illustrating a workflow processing method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. Initially, when assigning reference numerals to constituent elements of drawings, like reference numerals refer to like elements throughout although they are illustrated in different drawings. Also, in describing the present invention, when it is determined that detailed description related to a known function or configuration they may make the purpose of the present invention unnecessarily ambiguous, the detailed description will be omitted. Also, exemplary embodiments of the present invention will be described, however, the technical spirit of the present invention is not limited thereto or restricted thereby and may be modified by those skilled in the art and thereby be variously implemented.

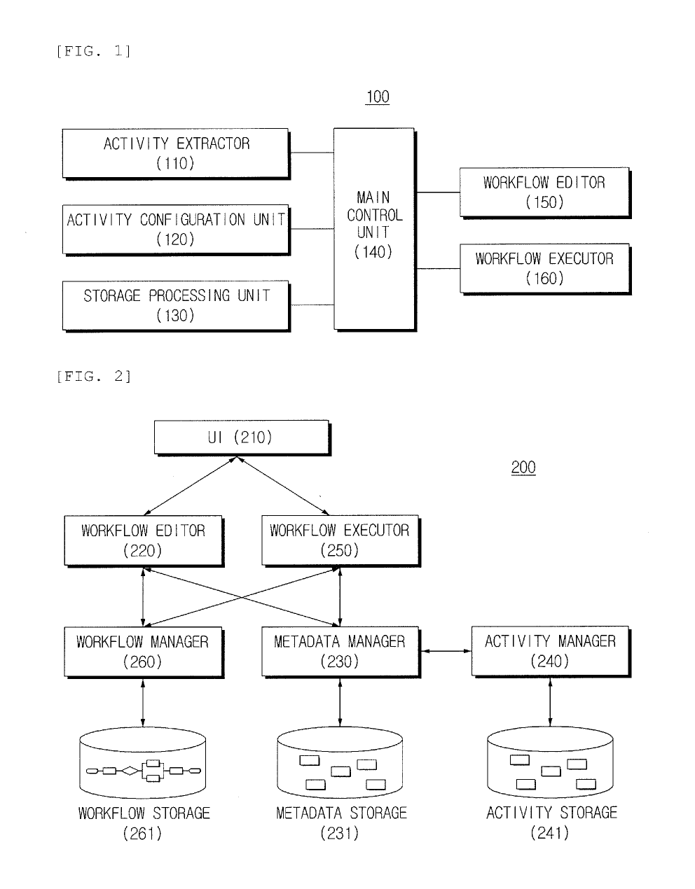

FIG. 1 is a block diagram schematically illustrating a workflow processing system 100 for supporting the multi-tenancy according to an exemplary embodiment of the present invention. Referring to FIG. 1, the workflow processing system 100 includes an activity extractor 110, an activity configuration unit 120, a storage processing unit 130, and a main control unit 140.

The workflow processing system 100 is a system for supporting the multi-tenancy and a system that configures an activity based workflow and manages metadata associated with an activity. In particular, the workflow processing system 100 is a system that configures a workflow and manages metadata in a software as a service (SaaS) environment of providing a software service to the multi-tenant online.

In the exemplary embodiment, the workflow processing system 100 is driven when tenants desire to share a single workflow.

The activity extractor 110 functions to extract at least one activity associated with a workflow for providing a software service. The activity extractor 110 extracts at least one activity that is selected from a control functioning activity, an allocation functioning activity, and a system interaction functioning activity.

The activity configuration unit 120 functions to configure an extracted activity based on a schema customized for a selected tenant.

The storage processing unit 130 functions to store a workflow that is an activity extraction target and the configured activity. The storage processing unit 130 may further store metadata that is used to associate the configured activity and the workflow that is the activity extraction target. The storage processing unit 130 may classify and thereby store each of the workflow that is the activity extraction target, the configured activity, and the metadata.

The main control unit 140 functions to control the overall operation of each of the components constituting the workflow processing system 100.

To support a single workflow instance to the multi-tenant, the workflow processing system 100 may further include a workflow editor 150 and a workflow executor 160.

When tenants request edition of the workflow, the workflow editor 150 functions to edit an edition requested workflow by overwriting a first activity, predetermined for each selected tenant, at a second activity location of the edition requested workflow. In the exemplary embodiment, the workflow editor 150 determines the first activity for each selected tenant based on metadata that is used to associate the configured activity and the workflow that is the activity extraction target. The workflow editor 150 determines the second activity associated with the first activity based on information about an identifier. The workflow editor 150 may perform activity serialization after overwriting but before completing the workflow edition.

The workflow executor 160 functions to execute an edited workflow for each tenant. Here, this function assumes that metadata exists. When the metadata does not exist, the workflow executor 160 functions to commonly execute an unedited workflow with respect to all tenants in which the metadata does not exist.

Meanwhile, the workflow processing system 100 may further include a workflow processing unit. The workflow processing unit functions to objectize the execution requested workflow.

The exemplary embodiment proposes a method of configuring a workflow to be suitable for a tenant environment in the multi-tenancy support environment, a method of managing a workflow activity as separate metadata so that activities of workflow may be configured to be suitable for a tenant when the multi-tenancy uses a single workflow instance, and the like. When different tenants using a single SaaS based service share, however, use different schemas (database tables) customized for each tenant, and desire to use a shared table, a workflow also requires a configuration to be suitable for a schema of each tenant. The exemplary embodiment proposes a method of configuring a single workflow instance when sharing the workflow instance by considering the above aspect. Hereinafter, an exemplary embodiment of the workflow processing system 100 will be described.

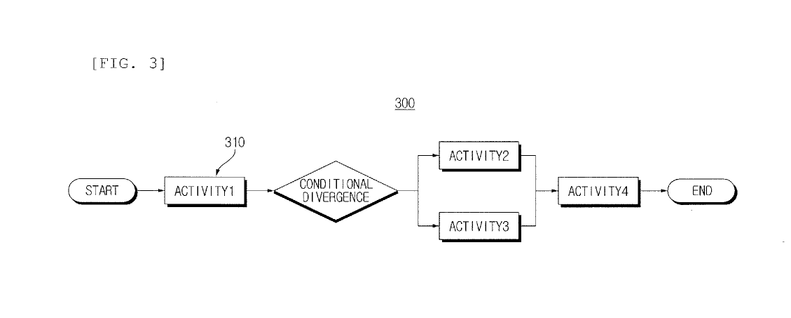

FIG. 2 is an exemplary diagram showing a system employing a workflow configuration method. A workflow system 200 of FIG. 2 provides a method of generating/managing/executing a workflow online using a user interface (UI) 210 such as a user browser. Also, the workflow system 200 provides a method of editing a workflow, defined through a workflow editor 220, for each tenant and a method of performing configuration for each activity that constitutes a workflow. Details configured for each activity may be stored as metadata about an activity in a metadata storage 231 using a metadata manager 230. The metadata manager 230 may store the activity itself in an activity storage 241 in interaction with an activity manager 240. When the user desires to execute the workflow for each tenant through a workflow executor 250, the user calls a basic workflow from a workflow storage 261 through a workflow manager 260. When corresponding tenant configuration information exists, the tenant configuration information is called through the metadata manager 230 and a workflow for each tenant is configured online and thereby is provided. In the meantime, when storing an activity through the workflow editor 220, metadata is stored for each activity. When a workflow execution request is received, the activity for each tenant is found and is overwritten with an activity having a corresponding identifier of a basic workflow.

As described above, the workflow system 200 provides a method of configuring a workflow, defined based on an activity, for each tenant and a method of storing and managing a configured activity as metadata. When a user belonging to a tenant desires to use a workflow, it is possible to achieve the effect as if the user uses a workflow allocated to the tenant when executing the workflow by reconfiguring the workflow configured using metadata defined for the tenant, and at the same time, to achieve the effect of low cost and high efficiency since only a single workflow instance is managed.

FIG. 3 illustrates an example of a generally executable workflow. Blocks shown in FIG. 3 are various examples of an activity 310 existing in a workflow 300. The activity 310 may be provided in various forms such as a control, an allocation, a system interaction, and the like.

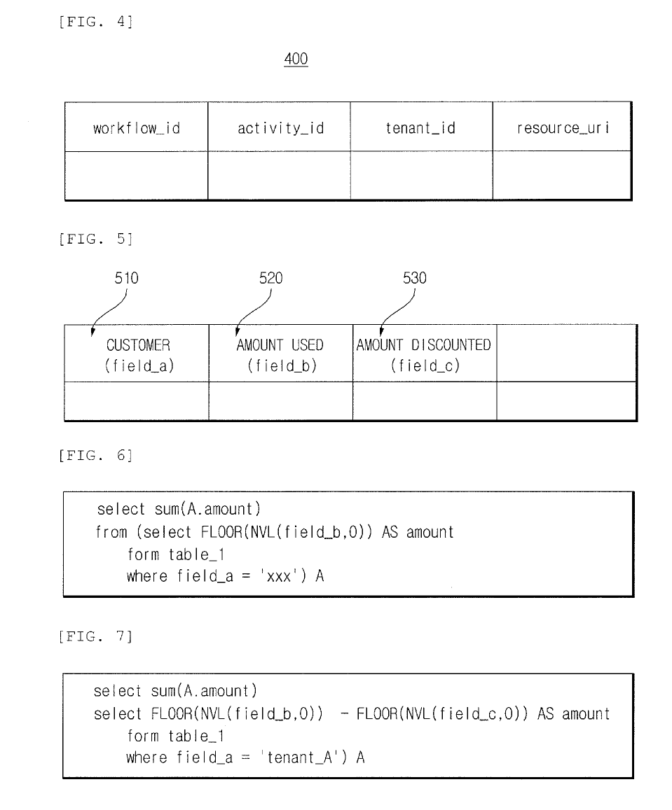

FIG. 4 illustrates an example of a schema in which the metadata manager of FIG. 2 stores metadata about an activity that is configured by a tenant with respect to a workflow. Each of the workflow and the activity has an allocated identifier (e.g., workflow_id and activity_id), and the tenant has a corresponding identifier (e.g., tenant_id). When the tenant configures activities of the workflow, the metadata manager adds corresponding information to an activity metadata table 400 and thereby manages, and stores a configured activity in an activity storage and stores a location thereof in a table together. Next, when a user belonging to a tenant executes the workflow, it is possible to execute a workflow customized for the tenant using the activity metadata table 400.

FIGS. 5 through 7 are diagrams to help understand an activity configuration method of a workflow. FIG. 5 illustrates an example of a database schema for storing purchase information of a customer in a web based SaaS service such as customer relationship management (CRM). Here, field_a 510 and field_b 520 are basic fields and field_c 530 is a field that is configured and thereby is added by a predetermined tenant A. That is, it is assumed that the tenant A separately manages an amount discounted using a coupon in addition to an amount used by a customer. To support such diversity of the customer, the above schema needs to be supported even in a workflow using data.

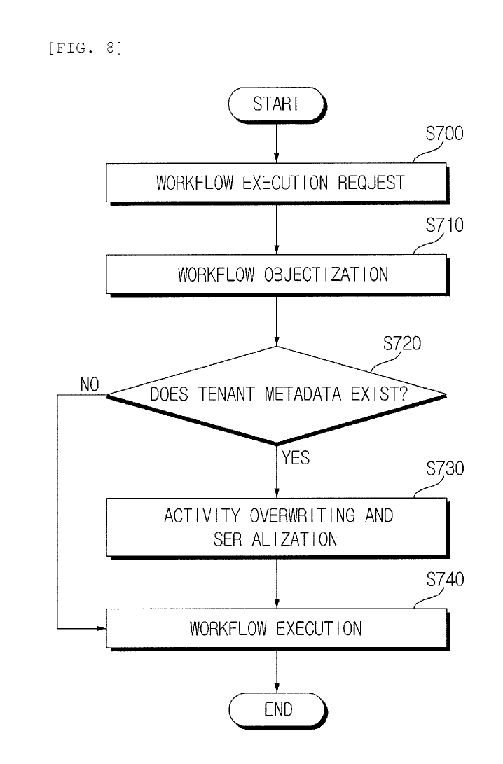

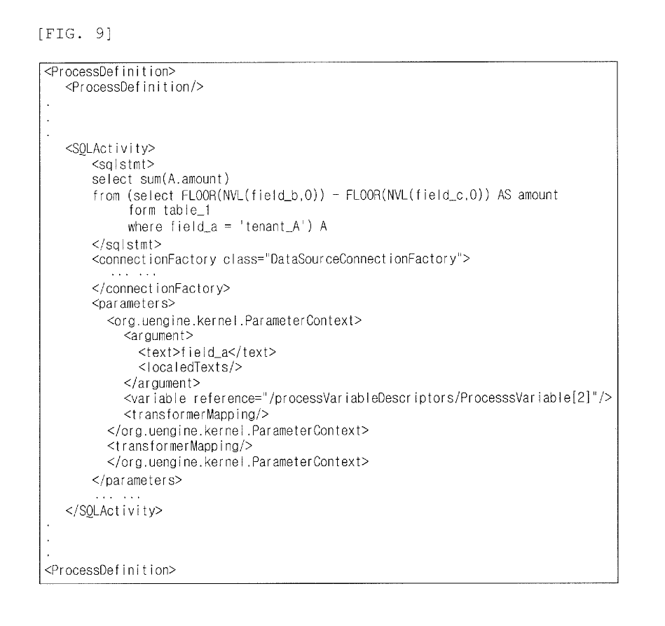

When it is assumed that a workflow for obtaining or data-mining statistics about purchase information of the customer using a table of FIG. 5 exists, there is a system interaction activity, particularly, a database interaction activity as an example of the workflow activity of FIG. 3. FIGS. 6 and 7 are examples of a query syntax to obtain a sum of amounts used for each customer from the purchase table of FIG. 5. FIG. 6 shows a query syntax for obtaining a sum of amounts used and FIG. 7 shows a query syntax for obtaining a sum of remaining amounts excluding amounts discounted from the amounts used. Here, it is assumed that FIG. 6 is an activity existing in a basic workflow and FIG. 7 is an activity configured by a predetermined tenant. When configuration about the workflow activity is allowed, the tenant A can obtain information customized for the form of original tenant using field_b and field_c that is additionally used by the tenant A.

FIG. 8 is an exemplary diagram illustrating a process of executing a workflow configured for each tenant by replacing an activity when a user requests a workflow execution. When a workflow execution request (S700) is received, workflow objectization (S710) is performed. Next, when there exists an activity configured through determining whether tenant metadata exists (S720), a basic activity within a workflow is overwritten and is serialized (S730). Next, the workflow is executed (S740). When the configured activity does not exist, an activity overwriting and serialization process is omitted and the workflow is executed.

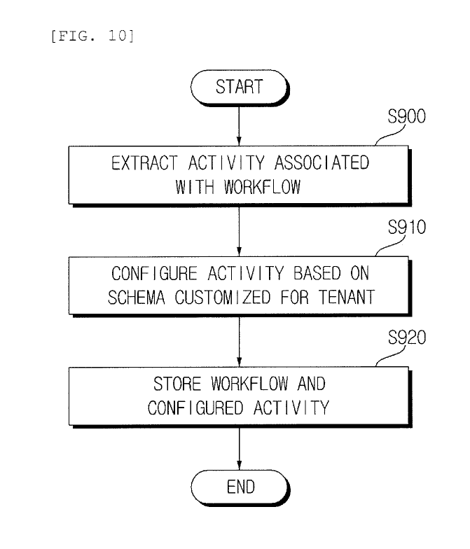

FIG. 9 is an exemplary diagram illustrating a workflow script serialized by overwriting a basic activity. FIG. 9 shows a workflow script overwritten and then serialized by calling a configuration activity using metadata when the tenant A described with reference to FIG. 7 requests the workflow. The database activity is indicated as SQLActivity and a query described with reference to FIG. 7 is shown in <sqlStmt/>.

Next, a workflow processing method of the workflow processing system 100 will be described. FIG. 10 is a flowchart illustrating a workflow processing method according to an exemplary embodiment of the present invention. The workflow processing method to be described below is performed when tenants desire to share a single workflow.

Initially, at least one activity associated with a workflow for providing a software service is extracted (activity extraction operation S900). The activity extraction operation S900 extracts at least one activity that is selected from a control functioning activity, an allocation functioning activity, and a system interaction functioning activity.

Next, an extracted activity based on a schema customized for a selected tenant is configured (activity configuration operation S910).

Next, a workflow that is an activity extraction target and the configured activity is stored (storage processing operation S920). In the storage processing operation S920, metadata that is used to associate the configured activity and the workflow that is the activity extraction target may be further stored. Also, in the storage processing operation S920, each of the workflow that is the activity extraction target, the configured activity, and the metadata may be classified and thereby be stored.

In the exemplary embodiment, a workflow edition operation and a workflow execution operation may be performed after the storage processing operation S920.

The workflow edition operation is an operation of editing an edition requested workflow by overwriting a first activity, predetermined for each selected tenant, at a second activity location of the edition requested workflow when tenants request an edition of the workflow. In the workflow edition operation, the first activity may be determined for each selected tenant based on metadata that is used to associate the configured activity and the workflow that is the activity extraction target. Also, in the workflow edition operation, the second activity associated with the first activity based on information about an identifier may be determined. Meanwhile, in the workflow edition operation, the execution requested workflow may be edited by performing activity serialization after overwriting.

The workflow execution operation is an operation of executing an edited workflow for each tenant when metadata exists. On the contrary, when the metadata does not exist, an unedited workflow is commonly executed with respect to all tenants in which the metadata does not exist.

In the meantime, the workflow processing operation may be performed between the workflow edition operation and the workflow execution operation. The workflow processing operation is an operation of objectizing the execution requested workflow.

The present invention may be applied to a SaaS platform development for providing a software service.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A workflow processing system for supporting the multi-tenancy, comprising:
an activity extractor to extract at least one activity associated with a workflow for providing a software service;
an activity configuration unit to configure an extracted activity based on a schema customized for a selected tenant; and
a storage processing unit to store a workflow that is an activity extraction target and the configured activity.

2. The system of claim 1, further comprising:
a workflow editor to edit an edition requested workflow by overwriting a first activity, predetermined for each selected tenant, at a second activity location of the edition requested workflow; and
a workflow executor to execute an edited workflow for each tenant.

3. The system of claim 2, wherein the workflow editor determines the first activity for each selected tenant based on metadata that is used to associate the configured activity and the workflow that is the activity extraction target.

4. The system of claim 2, wherein the workflow editor determines the second activity associated with the first activity based on information about an identifier.

5. The system of claim 3, further comprising:
a workflow processing unit to objectize the execution requested workflow,
wherein the workflow editor edits the execution requested workflow by performing activity serialization after the overwriting operation, and
when the metadata does not exist, the workflow executor commonly executes an unedited workflow with respect to all tenants in which the metadata does not exist.

6. The system of claim 1, wherein the storage processing unit further stores metadata that is used to associate the configured activity and the workflow that is the activity extraction target, and classifies and thereby stores each of the workflow that is the activity extraction target, the configured activity, and the metadata.

7. The system of claim 1, wherein the workflow processing system is driven when tenants desire to share a single workflow.

8. The system of claim 1, wherein the activity extractor extracts at least one activity that is selected from a control functioning activity, an allocation functioning activity, and a system interaction functioning activity.

9. A workflow processing method for supporting the multi-tenancy, the method comprising:
extracting at least one activity associated with a workflow for providing a software service;
configuring an extracted activity based on a schema customized for a selected tenant; and
storing a workflow that is an activity extraction target and the configured activity.

10. The method of claim 9, further comprising:
editing an edition requested workflow by overwriting a first activity, predetermined for each selected tenant, at a second activity location of the edition requested workflow; and
executing an edited workflow for each tenant.

11. The method of claim 10, wherein the editing of the workflow determines the first activity for each selected tenant based on metadata that is used to associate the configured activity and the workflow that is the activity extraction target.

12. The method of claim 10, wherein the editing of the workflow determines the second activity associated with the first activity based on information about an identifier.

13. The method of claim 11, further comprising:
objectizing the execution requested workflow,
wherein the editing of the workflow edits the execution requested workflow by performing activity serialization after the overwriting operation, and
when the metadata does not exist, the executing of the workflow commonly executes an unedited workflow with respect to all tenants in which the metadata does not exist.

14. The method of claim 9, wherein the storing of the workflow further stores metadata that is used to associate the configured activity and the workflow that is the activity extraction target, and classifies and thereby stores each of the workflow that is the activity extraction target, the configured activity, and the metadata.

15. The method of claim 9, wherein the workflow processing method is performed when tenants desire to share a single workflow.

16. The method of claim 9, wherein the extracting of the activity extracts at least one activity that is selected from a control functioning activity, an allocation functioning activity, and a system interaction functioning activity.
